(19) United States
(12) Patent Application Publication
(10) Pub. No.: US 2016/0167132 A1
(43) Pub. Date: Jun. 16, 2016

(54) ADDITIVE MANUFACTURING OF POROUS SCAFFOLD STRUCTURES

(71) Applicant: Washington State University, Pullman, WA (US)

(72) Inventor: Rahul Panat, Pullman, WA (US)

(21) Appl. No.: 14/957,849

(22) Filed: Dec. 3, 2015

Related U.S. Application Data
(60) Provisional application No. 62/090,319, filed on Dec. 10, 2014.

(51) Int. Cl. B22F 3/105; B28B 17/00; B28B 1/00

(52) U.S. Cl. CPC B22F 3/1055; B28B 1/001; B28B 17/0081; B22F 2003/1058; B33Y 10/00

(57) ABSTRACT

Techniques for additive deposition are disclosed herein. In one embodiment, a method includes depositing a first portion of a precursor material onto a deposition platform, the precursor material including a suspension of nano-particles and forming a first solid structure of the nano-particles on the deposition platform from the deposited first layer of the precursor material. The method can also include depositing a second portion of the precursor material onto the formed first solid structure of the nano-particles and forming a second solid structure on the first solid structure from the deposited second layer of the precursor material. The three dimensional structure thus formed can be partly or fully cured or sintered during deposition or after deposition resulting in a controlled hierarchical porosity at multiple levels, from mesoscale (e.g., about 10 μm to about 250 μm) to nanoscale (e.g., about 900 nm or less) in the same structure.

### CROSS-REFERENCE TO RELATED APPLICATION(S)

This application claims priority to U.S. Provisional Application No. 62/090,319, filed on Dec. 10, 2014.

### BACKGROUND

Porous structures with precisely controlled hierarchical porosity at different length scales, e.g., nano-scale or meso-scale, can have many industrial applications. For example, structures of an electrode material with hierarchical porosity can be used to release stress during lithiation of the electrode, allowing very high energy density batteries a reality. Further, porous structures of ceramic construction can be used as coatings of thermal barriers for insulating mechanical components from high temperature exposures in, for instance, gas turbines, diesel engines, or other types of machinery. By reducing operating temperatures of the insulated mechanical components, the porous structures can improve operating efficiencies as well as useful life of the machinery.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Even though porous scaffold structures with nanoscale or mesoscale porosity dimensions are useful in many industrial applications, manufacturing of such porous scaffold structures can involve long processing time, high costs, and can be environmentally harmful. Further, such conventional manufacturing techniques can create one level of porosity but typically do not create controlled hierarchical multi-level porosity. For example, one technique for producing such porous structures involves applying photolithography to sequentially deposit and/or remove portions of coating materials onto/from a substrate material. Such photolithography techniques typically require specialized equipment that is capital intensive as well as having long processing times, complex processes, utilization of environmentally harmful chemicals, large carbon footprints, and creation of process wastes. As a result, using photolithography techniques to produce porous materials at multiple length scales e.g., to create hierarchical porosity can be cost prohibitive and/or environmentally harmful.

Several embodiments of the disclosed technology are directed to techniques for efficiently and cost effectively producing porous structures having nanoscale or mesoscale porosity dimensions with enhanced control of at least one of (i) a structural profile, (ii) a structural dimension; or (iii) a porosity dimension of the scaffold structures. In certain implementations, an injector can controllably dispense a select amount of a precursor material (e.g., ink containing nanoscale particles) onto a substrate. The dispensed precursor material can then be generally instantaneously and/or post deposition cured, reacted, or otherwise hardened via, for instance, sintering or other suitable techniques. The hardened precursor material can then form a first layer of the scaffold structure having a particular structural profile (e.g., a grid), a structural dimension (e.g., grid dimension), and porosity dimension (e.g., grid spacing).

The injector can then controllably dispense another select amount of the precursor material (or a different precursor material) onto the hardened first layer, and subsequently cured to form a second layer having a target structural profile, structural dimension, and porosity dimension with respect to the second layer as well as in relation to the first layer. The foregoing injection and curing operations can then be repeated controllably to form a target scaffold structure having any desired structural profile, structural dimension, and porosity dimension. In certain embodiments, a composition of the precursor material can also be selected such that the formed scaffold structure has structure components (e.g., grid segments between vertices) that also have a desired porosity.

In certain embodiments, the injector can also controllably deposit the precursor material onto the substrate, with the precursor material sufficiently hardened or partially cured to create an element of the scaffold (e.g. one or more pillars). The element may be vertical or at an angle with respect to the substrate. Several such elements can be printed to form the scaffold. Upon full curing, the elements can have their own nanoscale or other suitable scale porosity due to sintering of the nanoparticles.

As discussed in more detail below, several embodiments of the disclosed technique can provide sufficient controllability to form a variety of scaffold structures from tens of micrometer to nanoscale with target structural features without the need for specialized equipment such as when applying photolithography. Several embodiments of the disclosed technology also have lower operational complexity, shorter processing time, and thus lower costs of manufacturing and reduced environmental impact than conventional techniques.

### BRIEF DESCRIPTION OF THE DRAWINGS

FIG. 1 is a schematic diagram of an additive deposition system in accordance with embodiments of the disclosed technology.

FIGS. 2A-2F are perspective diagrams showing operations of an additive manufacturing process using the additive deposition system of FIG. 1 in accordance with embodiments of the disclosed technology.

FIGS. 3A-3F are perspective diagrams showing operations of another additive manufacturing process using the additive deposition system of FIG. 1 in accordance with additional embodiments of the disclosed technology.

FIG. 4 is a perspective diagram showing an example porous scaffold structure that can be manufactured using the additive manufacturing process of FIGS. 2A-2F in accordance with embodiments of the disclosed technology.

FIGS. 5A-5H are photographs and scanning electron microscope (“SEM”) images of an example porous scaffold structure of silver (Ag) manufactured using the additive manufacturing process of FIGS. 2A-2F or 3A-3C in accordance with embodiments of the disclosed technology.

FIGS. 6A-6B are schematic diagrams of an energy storage device having electrodes incorporating porous scaffold structures prepared in accordance with embodiments of the disclosed technology during various operating modes.

FIG. 7 is a cross-section diagram of a mechanical component having a thermal barrier coating incorporating porous scaffold structures prepared according to several embodiments of the disclosed technology.

### DETAILED DESCRIPTION

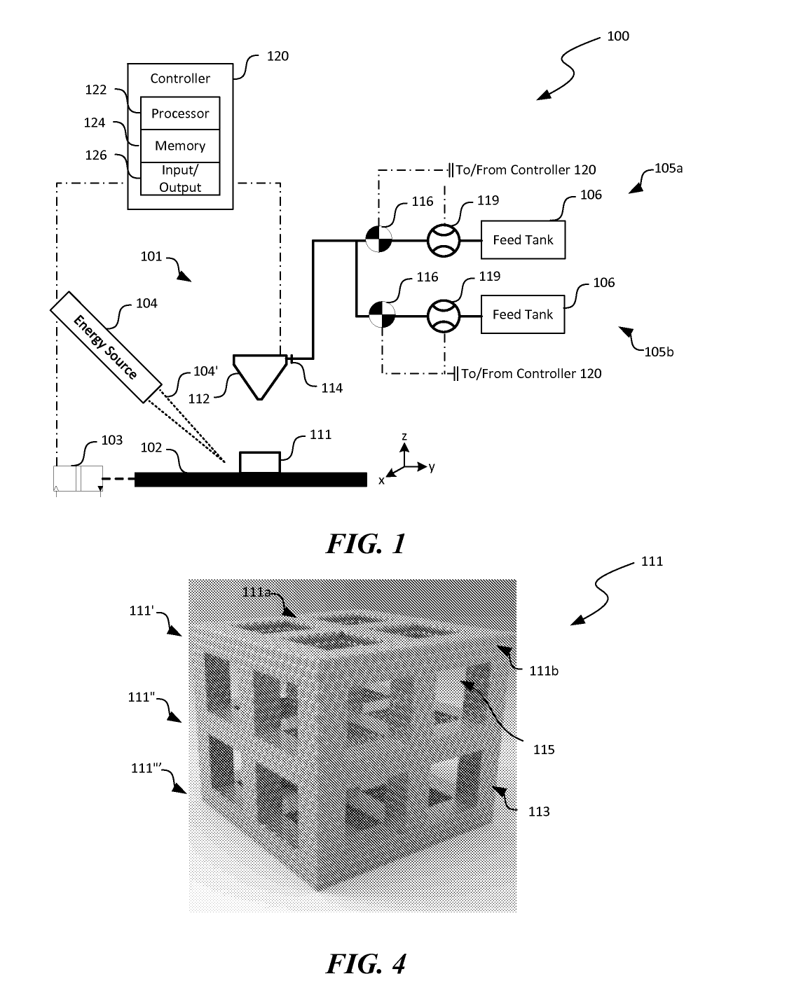

Certain embodiments of systems, devices, articles of manufacture, and processes for additive manufacturing of porous scaffold structures are described below. In the following description, specific details of components are included to provide a thorough understanding of certain embodiments of the disclosed technology. A person skilled in the relevant art will also understand that the disclosed technology may have additional embodiments or may be practiced without several of the details of the embodiments described below with reference to FIGS. 1-6B.

As used herein, the term “additive deposition” generally refers to a process in which portions or layers of materials are deposited or otherwise formed in an accumulative manner and without removal of the deposited material. For example, as described in more detail below, several embodiments of the disclosed technology can be used to produce porous scaffold structures in a layer-by-layer manner. The formed porous scaffold structures can include hierarchical mesoscale e.g., about 10 μm to about 250 μm) and/or nanoscale (e.g., less than about 500 nm) porosity. In other embodiments, the porous scaffold structures can also be formed in a section-by-section or other suitable manners.

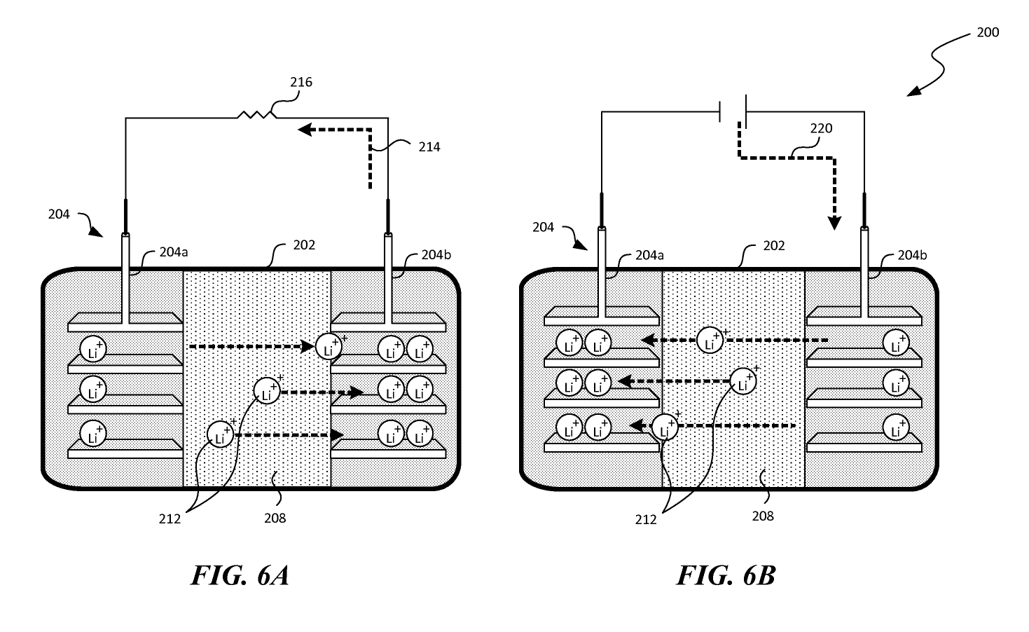

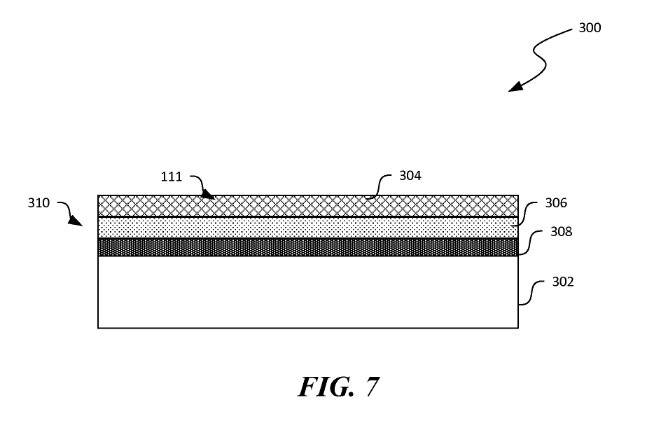

Several embodiments of the disclosed technology can be applied to form various products or components. For example, as described in more detail below with reference to FIGS. 6A-6B and 7, the disclosed technology can be used to form electrodes with high charge capacities for batteries or other types of electronic devices or thermal barrier coatings on mechanical components. In other examples, the disclosed technology can also be applied to form the following products or components:
Thermal insulation structures for high temperature applications such as in gas turbines, diesel engines, or other types of machinery;
Gas (e.g., hydrogen) storage components or catalytic converters (e.g., of molybdenum disulfide) with high surface to volume ratio and reactant penetration;
Compliant interconnects, for example, of tin-copper or tin-silver-copper for electronic devices;
Ultra-high vacuum gas absorbers with high surface-to-volume ratios;
Structural components with high strength to volume ratios;
Desalination and/or other filtration components;
Highly hydrophobic or hydrophilic materials; and
Implantable tissue scaffold components for drug delivery, bio-structural support, or other suitable purposes.
   The foregoing examples are for illustrative purposes only. One of ordinary skilled in the art would realize that embodiments of the disclosed technology may be utilized for other suitable applications.

FIG. 1 is a schematic diagram of an additive deposition system 100 in accordance with embodiments of the disclosed technology. As shown in FIG. 1, the additive deposition system 100 can include a deposition platform 102, an energy source 104, a first feed line 105a, a second feed line 105b, and a controller 120 operatively coupled to one another. Even though particular components are illustrated in FIG. 1, in other embodiments, the additive deposition system 100 can also include additional and/or different components. For example, even though two feed lines 105a and 105b are shown in FIG. 1, in other embodiments, the additive deposition system 100 can also include one, three, four, or any suitable number of feed lines for delivering one or more precursor materials.

As shown in FIG. 1, the deposition platform 102 can be configured to carry a substrate having a substrate material (not shown) or a formed porous scaffold structure 111 (shown as a cylinder for illustration purposes). The deposition platform 102 can also include an actuator 103 configured to move the deposition platform 102 in x-, y-, and z-axis in a raster scan, continuous scan, or other suitable manners. In certain embodiments, the actuator 103 can include one or more electric motors controlled by, for example, the controller 120 or other suitable logic processors (not shown) to perform various scanning operations. In other embodiments, the actuator 103 can include pneumatic actuators and/or other suitable types of drives configured to perform the scanning operations.

The energy source 104 can be configured to provide an energy stream 104′ into a deposition environment 101. In certain embodiments, the energy source 104 can include an Nd:YAG or any other suitable types of laser capable of delivering sufficient energy to the deposition environment 101. In other embodiments, the energy source 104 can also include illumination, radiation, microwave, plasma, electron beam, induction heating, resistance heating, or other suitable types of energy sources. In certain embodiments, the additive deposition system 100 can include collimators, filters, mirrors, waveguides (not shown) configured to direct the energy stream 104′ into the deposition environment 101. In other embodiments, the additive deposition system 100 can also include other suitable optical and/or mechanical components (not shown) configured to direct and deliver the energy stream 104′. In certain embodiments, the substrate 102 can be heated to provide sufficient energy to harden and/or cure any precursor material(s) deposited on the substrate.

As shown in FIG. 1, the first and second feed lines 105a and 105b can be configured to deliver first and second precursor materials (e.g., metallic or ceramic nanoparticles) to the deposition environment 101, respectively. In certain embodiments, the precursor materials can include a suspension of nano-particles of silicon (Si), tin (Sn), tin oxide (SnO₂) or other Li-carrying compositions. In other embodiments, the precursor materials can include YSZ (Yittria Stabilized Zirconia), HSZ (Hafnia stabilized zirconia) or other suitable ceramic materials. In further embodiments, the precursor materials can also include copper (Cu), graphite (C), or other suitable composition for particular applications.

The first and second feed lines 105a and 105b can be configured to supply the same, similar, or different precursor materials to the deposition environment 101. In the illustrated embodiment, each feed line 105a and 105b includes a feed tank 106, a valve 116, and a feed rate sensor 119. The feed tanks 106 can individually include a storage enclosure suitable for storing a corresponding precursor material. The valves 116 can each include a gate value, a globe valve, or other suitable types of valves. The feed rate sensor 119 can each include a mass meter, a volume meter, or other suitable types of meter.

In certain embodiments, the precursor materials can include a solution of nanoparticles of, for instance, silicon, carbon, molybdenum di-sulfide, silver or other suitable materials. In other embodiments, the precursor materials can also include a powder of such nanoparticles. In such embodiments, the additive deposition system 100 may also include one or more carrier gas sources (e.g., argon or nitrogen, not shown) configured to deliver the powder precursor materials to the deposition environment 101. In further embodiments, the first and second feed lines 105a and 105b can individually include other suitable components.

The additive deposition system 100 can also include a deposition head 112 configured to controllably deliver the precursor materials from the first and/or second feed lines 105a and 105b to the deposition platform 102. In certain embodiments, the deposition head 112 can be configured to deliver or dispense the precursor materials using gravity. In other embodiments, the deposition head can also utilize a pump, compressed gas, and/or other suitable driving mechanisms. The deposition head 112 can include one or more feed ports 114 configured to receive the precursor materials from the first and/or second feed lines 105a and 105b. In the illustrated embodiment, the deposition head 112 has a generally conical shape. In other embodiments, the deposition head 112 can have other suitable shapes and/or structures.

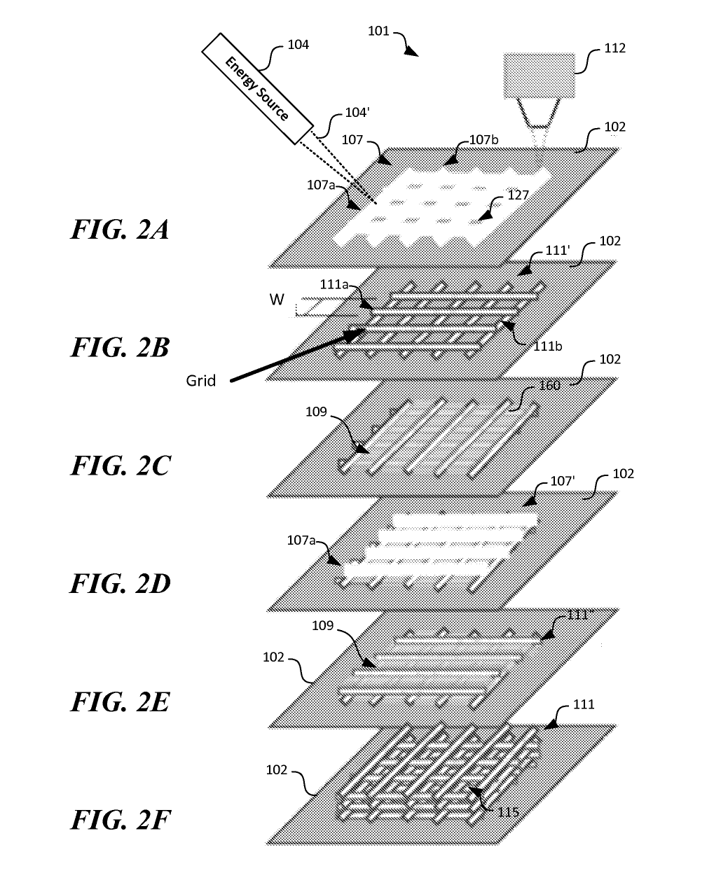

The controller 120 can include a processor 122 coupled to a memory 124 and an input/output component 126. The processor 122 can include a microprocessor, a field-programmable gate array, and/or other suitable logic devices. The memory 124 can include volatile and/or nonvolatile computer readable media (e.g., ROM; RAM, magnetic disk storage media; optical storage media; flash memory devices, EEPROM, and/or other suitable non-transitory storage media) configured to store data received from, as well as instructions for, the processor 122. In one embodiment, both the data and instructions are stored in one computer readable medium. In other embodiments, the data may be stored in one medium (e.g., RAM), and the instructions may be stored in a different medium (e.g., EEPROM). In operation, the processor 122 can execute the instructions stored in the memory 124 to perform a process, such as the process described in more detail below with reference to FIGS. 2A-2F. The input/output component 126 can include a display, a touch screen, a keyboard, a track ball, a gauge or dial, and/or other suitable types of input/output devices.

In certain embodiments, the controller 120 can include a computer operatively coupled to the other components of the additive deposition system 100 via a hardwire communication link (e.g., a USB link, an Ethernet link, an RS232 link, etc.). In other embodiments, the controller 120 can include a logic processor operatively coupled to the other components of the additive deposition system 100 via a wireless connection (e.g., a WIFI link, a Bluetooth link, etc.). In further embodiments, the controller 120 can include an application specific integrated circuit, a system-on-chip circuit, a programmable logic controller, and/or other suitable computing frameworks

In operation, the controller 120 can receive a desired design file for a target structure, product, or article of manufacture, for example, in the form of a computer aided design (“CAD”) file or other suitable types of file. The design file can also specify at least one of a composition, a structural profile, a structural dimension, a porosity dimension, or other desired properties of the structure. In response, the controller 120 can analyze the design file and generate a recipe having a sequence of operations to form the structure via reactive deposition in layer-by-layer, section-by-section, or other suitable accumulative fashion. One example of the operation of the additive deposition system 100 is described in more detail below with reference to FIGS. 2A-2F.

FIGS. 2A-2F are perspective diagrams showing operations of an additive manufacturing process using the additive deposition system 100 of FIG. 1 in accordance with embodiments of the disclosed technology. In FIG. 2A-2F, certain components of the additive deposition system 100 shown in FIG. 1 are omitted for clarity.

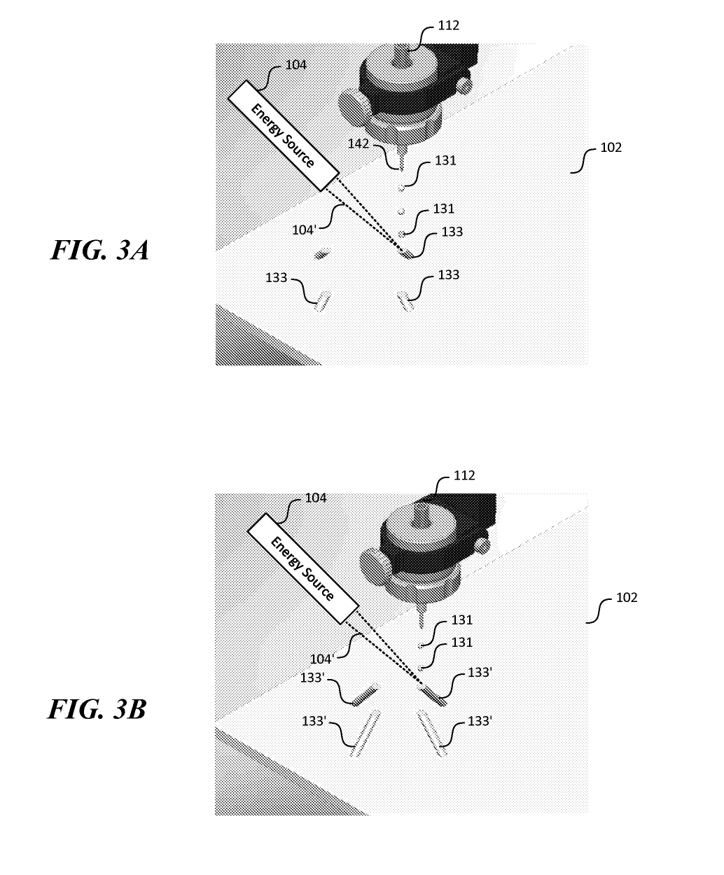

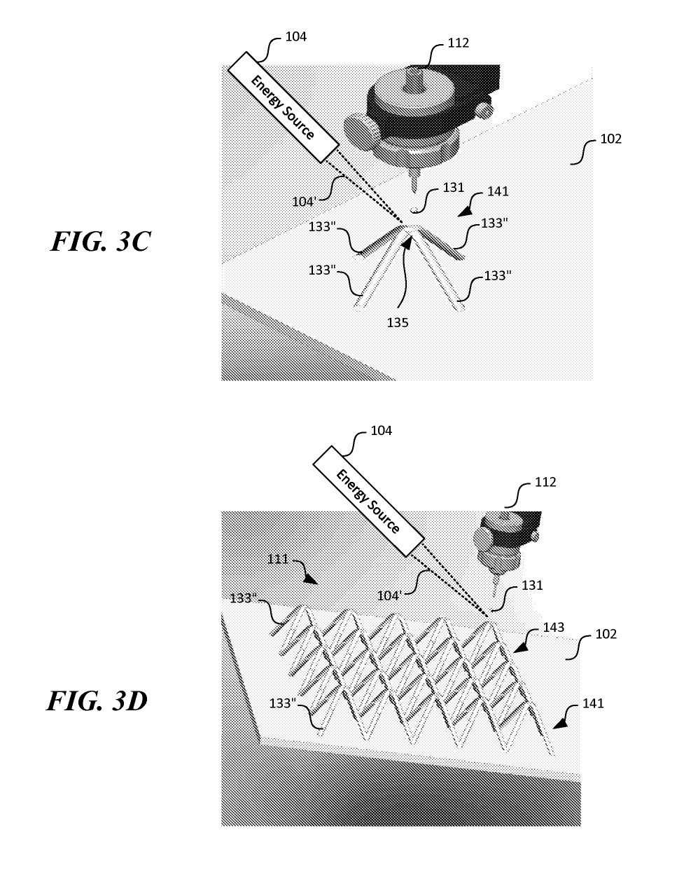

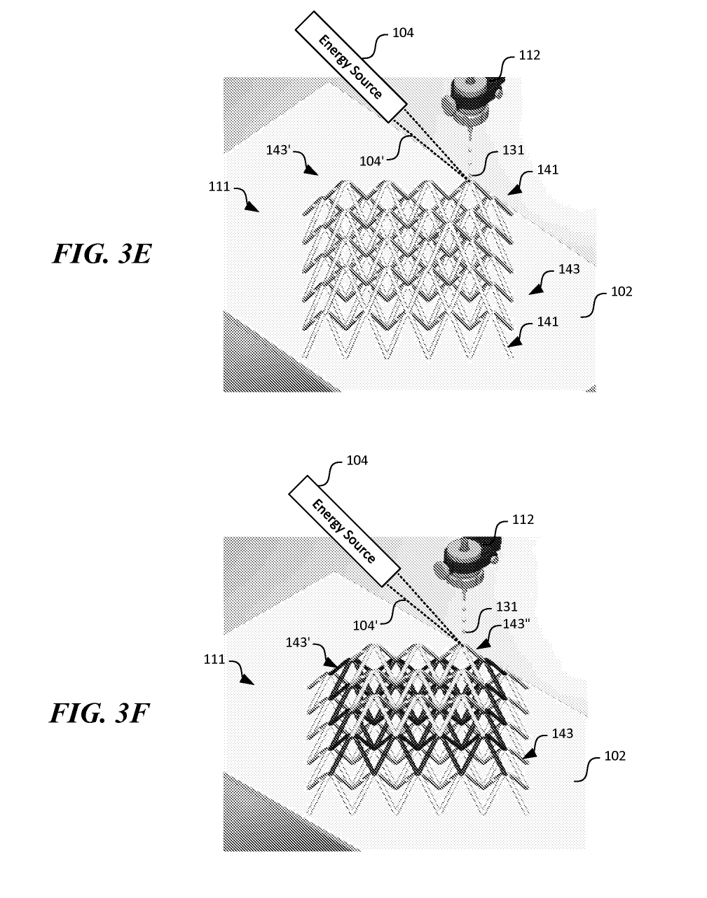

As shown in FIG. 2A, the process can include initially depositing a first layer 107 of one or more precursor materials onto the deposition platform 102 via the deposition head 112. The controller 120 (FIG. 1) can instruct one or more of the valves 116 to allow a target rate of precursor material into the deposition environment 101, for example, by implementing a PID control based on a reading of the one or more feed rate sensors 119. The controller 120 can also control at least one of the deposition head 112 or the actuator 103 (FIG. 1) such that the deposited first layer 107 of the precursor material can form a target pattern on the deposition platform 102. For example, as shown in FIG. 2A, the deposited precursor material forms a grid having intersecting rows 107a and columns 107b separated by multiple voids 127. In other embodiments, the deposited precursor material can form other concentric circles, ovals, stars, or any other suitable patterns. In further embodiments, the deposited precursor material can also form a pillar or other suitable structures as successive droplets that freeze when reaching the substrate or a previously hardened droplet to form a vertical pillar or a pillar at an angle (e.g., about 1° to about 179°) with respect to the deposition platform 102, as described in more detail below with reference to FIGS. 3A-3F.

The process can then include sintering or otherwise curing the first layer 107 of the deposited precursor material. For example, as shown in FIG. 2A, the controller 120 can instruct the energy source 104 to deliver the energy stream 104′ to the first layer 107 of the deposited precursor material as the precursor material is deposited. The provided energy stream 104′ can in turn cause the deposited precursor material to undergo polymerization, crystallization, sintering, solvent exfoliation, or other suitable chemical/physical transformations. The energy stream 104′ can generally instantaneously or in other suitable manners harden or cure the first layer 107 of the deposited precursor material. As a result, the first layer 107 of the deposited precursor material can form a layer of solid structure 111′ as shown in FIG. 2B.

In the illustrated embodiment shown in FIG. 2B, the formed first layer of solid structure 111′ includes a grid having multiple rows 111a and columns 111b spaced apart from one another at target spacing dimensions. For instance, the multiple rows 111a can be spaced apart from one another by a dimension W. In certain embodiments, the dimension W can be measured and the measurement provided to the controller 120. The controller 120 can then adjust at least one of more of the feed rate of the precursor material, the motion of the deposition head 112 and/or the actuator 103, the exposure time/intensity of the energy stream 104′ to achieve a target spacing dimension between the rows 111a. In other embodiments, similar or different techniques may be applied to adjust a spacing dimension between the columns 111b, the dimensions of the rows 111a and/or columns 111b, or other structural characteristics of the formed structure 111′.

As shown in FIG. 2C, in certain embodiments, the process can optionally include depositing a sacrificial material 109 onto the first layer of formed solid structure 111′. The sacrificial material 109 can provide mechanical support, chemical resistance, or other suitable functions to the formed solid structure 111′. The sacrificial material 109 can include a polymer or other suitable compositions removable via, for example, heating, photo exposure, or dissolution in solvents, or other suitable techniques. In other embodiments, deposition of the sacrificial material may be omitted, and the process may proceed directly to depositing a second layer 107′ of the precursor material as shown in FIG. 2D.

In certain embodiments, the deposition of the second layer 107′ can be generally similar to that of the first layer 107. As such, the second layer 107′ can include the same or similar deposited precursor material, structural profile, or other characteristics as the first layer 107. In other embodiments, deposition of the second layer 107′ can be different than that of the first layer 107. In certain examples, the second layer 107′ can include a different precursor material than the first layer 107, for instance, from the second feed line 105b (FIG. 1) instead of the first feed line 105a (FIG. 1). In other examples, the second layer 107′ can also have a different structural profile than the first layer 107 by having, e.g., different dimensions of rows 107a, columns 107b, or spacing dimensions between neighboring rows 107a and columns 107b. For instance, as shown in the illustrated embodiment in FIG. 2D, the second layer 107′ only includes rows 107a but not columns 107b.

The process can also include sintering or otherwise curing the second layer 107′ of the deposited precursor material to form a second layer of solid structure 111″, as shown in FIG. 2E. In certain embodiments, forming the second layer of solid structure 111″ can be generally similar to that of forming the first layer of solid structure 111′. In other embodiments, different techniques may be implemented because, for example, the second layer 107′ contains different precursor material than the first layer 107 (FIG. 2A) or for other suitable operational reasons.

The process then include repeating the operations shown in FIGS. 2A-2E to form the target structure 111 as shown in FIG. 2F. The target structure 111 can include multiple layers separated by multiple pores 115. In certain embodiments, the process can optionally include removing the sacrificial material 109 (FIGS. 2C and 2E). In other embodiments, removing the sacrificial material 109 can be omitted. In further embodiments, the process can also include polishing, annealing, or performing other suitable treatments. An example of the formed structure 111 is described in more detail below with reference to FIG. 3.

Several embodiments of the disclosed technology can be more efficient and cost-effective in forming porous scaffold structures than conventional techniques. For example, as described above with reference to FIGS. 1-2F, the additive deposition system 100 does not require specialized equipment, nor does it utilize harmful chemicals or create waste in the processing operations. Several embodiments of the additive deposition process can also provide precise control to form the target structure 111 with a target (i) structural profile, (ii) structural dimension; or (iii) porosity dimension.

Even though the process shown in FIGS. 2A-2F is illustrated with two-dimensional formation for each layers of the formed structure 111, in other embodiments, the additive deposition system of FIG. 1 can also be configured to construct three-dimensional mesoscale (or other suitable scale) scaffold structures for the individual layers of the formed solid structure 111. For example, FIGS. 3A-3F are perspective diagrams showing operations of another additive manufacturing process using the additive deposition system of FIG. 1 in accordance with additional embodiments of the disclosed technology.

As shown in FIG. 3A, deposition head 112 can include a needle-like or other suitably configured dispenser 142 to successively dispense a small amount, for example, as droplets 131 (or a bead, dot, or other suitable formations) of the precursor material onto the deposition platform 102. In certain embodiments, the energy source 104 can provide the energy stream 104′ to each of the dispensed droplets 131 to harden and/or otherwise cured the dispensed droplets 131 to form a three-dimensional structure 133 on the deposition platform 102. In other embodiments, the deposition platform 102 can be heated to at least facilitate curing of the droplets 131 in addition to or in lieu of the energy stream 104′.

In the illustrated embodiment in FIG. 3A, the three-dimensional structures 133 are shown as a pillar at an angle (e.g., about 30° to about 60°) with respect to the deposition platform 102. Such three-dimensional structures 133 can be formed by, for example, adjusting position of the deposition head 112 and/or the deposition platform 102 in relation to dispensing each of the droplets 131. In other embodiments, the three-dimensional structure 133 can also include vertical pillars, slabs, or other suitable structure. As shown in FIG. 3B, the operations shown in FIG. 3A can be repeated such that the three-dimensional structures 133′ can be lengthened. In FIG. 3B, four converging three-dimensional structures 133′ are shown for illustration purposes. In other embodiments, any suitable numbers of the three-dimensional structures 133′ can be formed and/or lengthened in any suitable manners.

As shown in FIG. 3C, repeating the operations shown in FIGS. 3A and 3B can result in formation of a first three-dimensional scaffold 141 on the deposition platform 102. In the illustrated embodiment, the three-dimensional scaffold 141 includes four canted pillars converging at an apex 135. In other embodiments, the three-dimensional scaffold 141 can include any suitable number of pillars in suitable arrangements. The operations shown in FIGS. 3A-3C can then be repeated to form a first layer 143 of the solid structure 111, as shown in FIG. 3D.

As shown in FIG. 3E, the operation shown in FIGS. 3A-3D can be repeated to form a second layer 143′ of the solid structure 111 by dispensing and curing droplets 131 of the precursor material onto the formed first layer 143. In the illustrated embodiment, the second layer 143′ includes three-dimensional scaffolds 141 that are generally similar in dimension and structure to those of the first layer 143. In other embodiments, the second layer 143′ can include three-dimensional scaffolds (not shown) that are different in at least one of dimension or structure than those of the first layer 143. Similarly, the operations shown in FIGS. 3A-3E can be repeated to form a third layer 143″ on the second layer 143′ of the solid structure 111. Even though only three layers 143, 143′, and 143″ are illustrated in FIG. 3F, the operations may be repeated to form any suitable number of layers of the solid structure 111.

FIG. 4 is a perspective diagram showing an example porous scaffold structure 111 that can be manufactured using the additive manufacturing process of FIGS. 2A-2F or FIG. 3A-3F in accordance with embodiments of the disclosed technology. As shown in FIG. 4, the porous scaffold structure 111 can include multiple layers interconnected with one another by cross members 113 and spaced apart from one another by multiple pores 115. In the illustrated embodiment, three layers (identified individually as first, second, and third layer 111′, 111″, and 111′″, respectively) are shown for illustration purposes. In other embodiments, the porous scaffold structure 111 can include any suitable number of layers.

As shown in FIG. 4, each of the multiple layers 111′, 111″, and 111′″ can include multiple rows 111a and multiple columns 111 b. Each pair of neighboring rows 111a and columns 111b are spaced apart from one another by a corresponding pore 115. Each of the pores 115 can be mesoscale e.g., about 10 μm to about 250 μm. In the illustrated embodiment, the multiple pores 115 have generally similar dimensions. In other embodiments, at least one of the pores 115 can have a different shape or dimension than other pores 115. In further embodiments, one or more of the layers 111′, 111″, and 111′″ can have a different configuration or material than other layers.

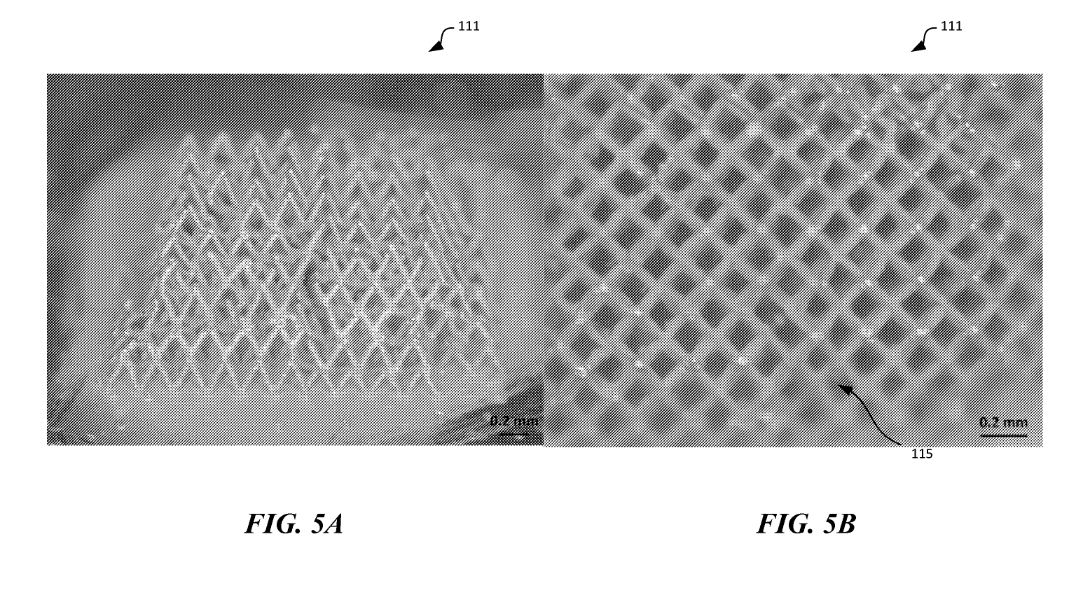

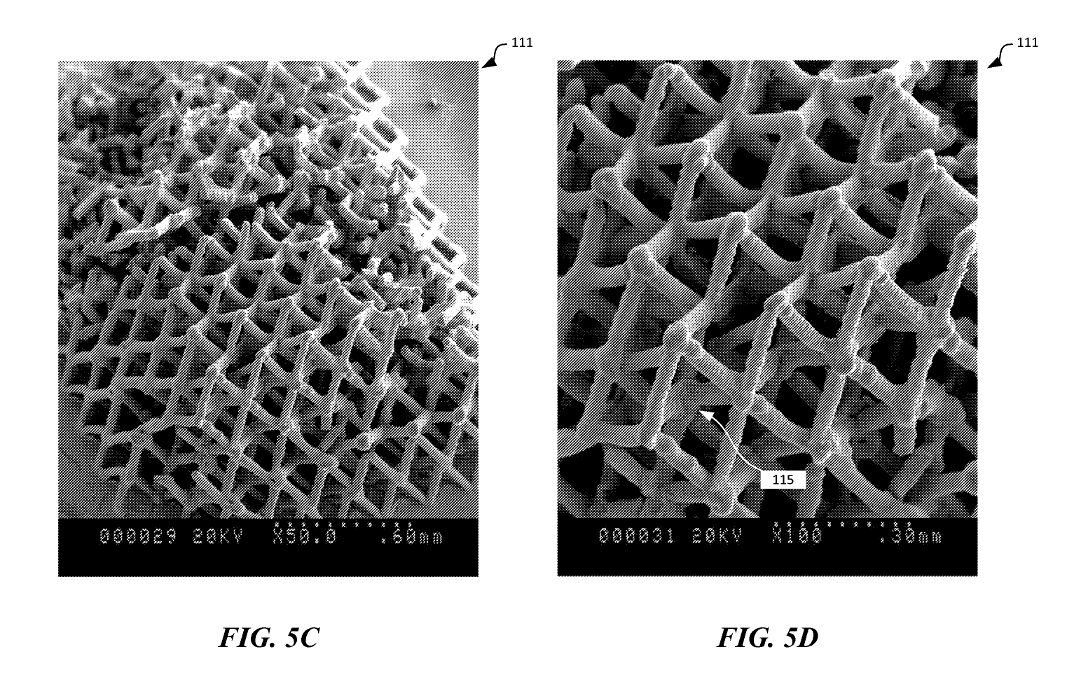

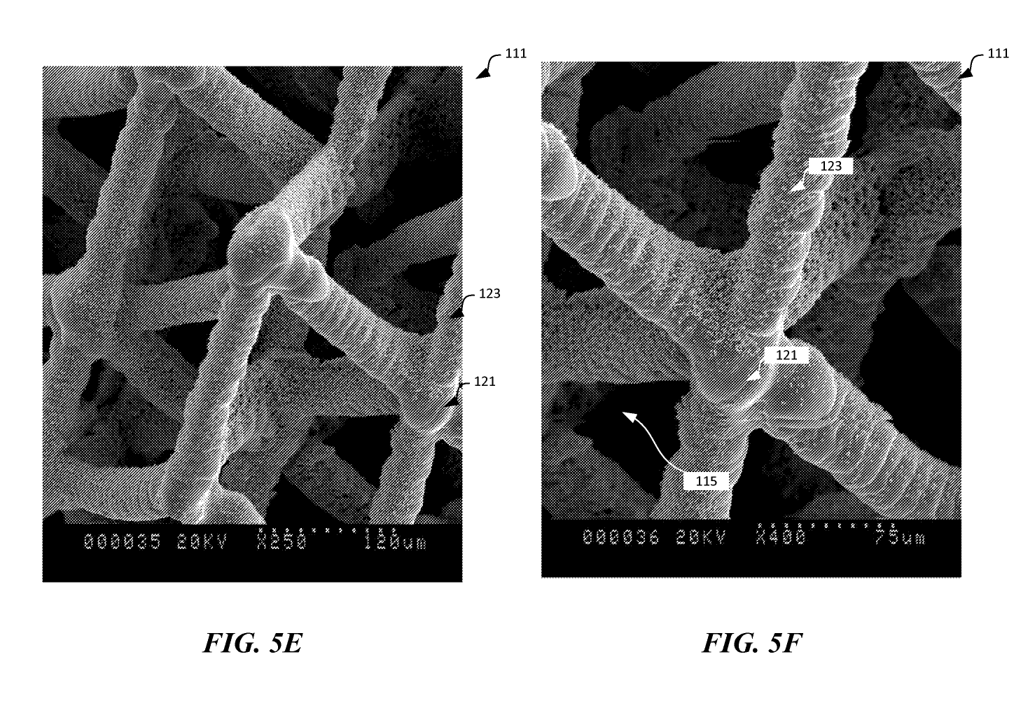

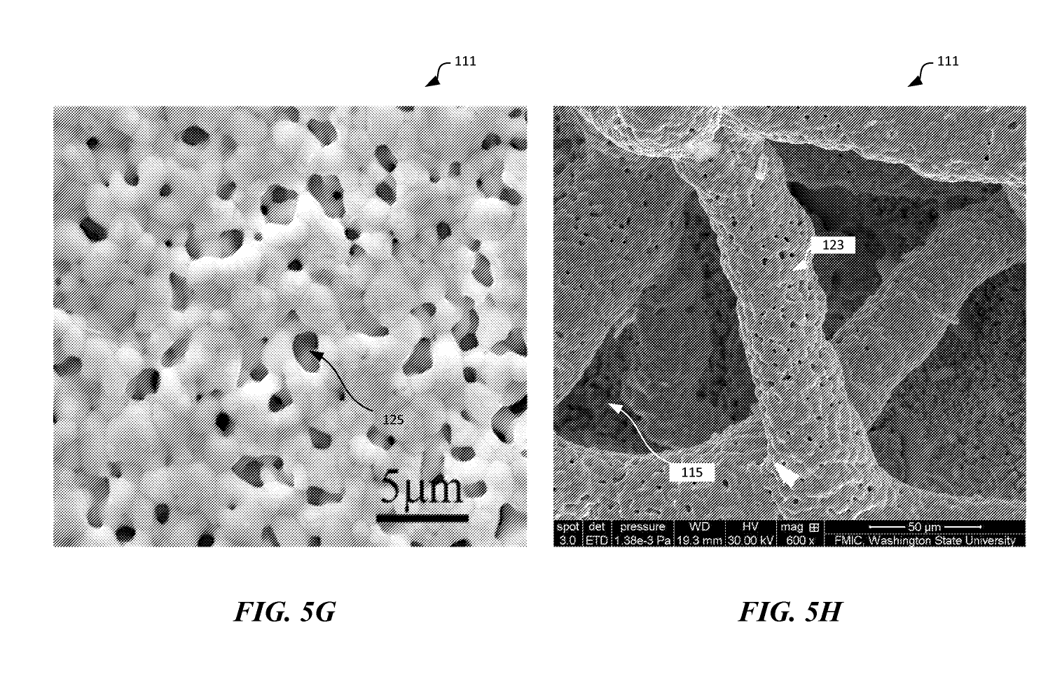

In certain embodiments, the rows 111a, columns 111b, or cross members 113 can also contain porosity at a smaller scale than the pores 115. For example, in one embodiment, the rows 111a, columns 111b, or cross members 113 can be formed using select nano particles such that each layer 111′, 111″, and 111′″ includes a porous rows 111a and columns 111b. Example SEM images of such porosity are described in more detail below with reference to FIG. 5G and FIG. 5H. In other examples, the rows 111a, columns 111b, or cross members 113 can be structures generally without porosity.

### Experiments

Certain experiments were conducted to form porous scaffold structures using an additive deposition system generally similar to that described above with reference to FIG. 1 according to the process described above with reference to FIGS. 2A-2F and FIG. 3A-3F. A powder of silver (Ag) nano-particles in a suspension (e.g. ethylene glycol and water) was printed with multiple passes on a current collector for batteries. Multiple passes resulted in thickness of one scaffold lines being about 5-10 μm. The lines were then sintered at high temperature. A sacrificial layer (e.g. a polymer) was then printed to provide mechanical support for the next level of lines for the scaffold. This was then followed by next layer of Ag nano-particles printing and sintering. A camera was used to ensure connectivity of a preceding layer with a next layer. The thermal sintering or chemical removal of the sacrificial polymer was then performed. This process was then repeated until the target scaffold is constructed.

FIGS. 5A-5G are photographs and SEM images of an example porous scaffold structure of silver (Ag) manufactured using the additive manufacturing process of FIGS. 3A-3F in accordance with embodiments of the disclosed technology. For example, FIG. 5A shows a perspective view and FIG. 5B shows a top view of the example porous scaffold structure at 0.2 mm scale. As shown in FIGS. 5A and 5B, the porous scaffold structure 111 can include multiple layers of repeating patterns with hierarchical porosity. Such repeating pattern and porosity can be more clearly seen in FIG. 5C and 5D, which are SEM images of the porous scaffold structure at 50× and 100× magnification, respectively.

FIGS. 5E and 5F are SEM images of the porous scaffold structure 111 at 250× and 400× magnification, respectively. As shown in FIGS. 5E and 5F, the porous scaffold structure 111 can include a matrix having multiple vertices 121 interconnected to neighboring vertices 121 by frame members 123. As such, the multiple frame members 123 connecting the vertices 121 can form a scaffold structure with a high degree of porosity.

FIGS. 5G and 5H are SEM images of the porous scaffold structure 111 showing porosity of the frame members 123. As shown in FIGS. 5G and 5H, each of the frame members 123 can also include porosity in addition to the pores 115. The line pores 125 can further enhance the porosity of the scaffold structure 111.

Embodiments of the porous scaffold structure 111 can have many industrial applications. As described below with reference to FIGS. 6A and 6B, embodiments of the porous scaffold structure 111 can be used as high charge capacity electrodes for batteries or other electronic devices. Even though a battery is used to illustrate the application of the porous scaffold structure 111, embodiments of the scaffold structure 111 can also be used in other suitable applications.

Certain materials can have high strain energy density than conventional electrode materials. For example, silicon (Si) has a specific charge capacity of 4000 mAh/g while commercially used graphite has a specific charge capacity of 370 mAh/g. However, without being bound by theory, it is believed that such high strain energy density electrode materials such as silicon (Si) can undergo severe volume expansion during charging. As such, use of such bulk silicon (Si) as electrodes can result in electrode pulverization and early capacity fades.

To address this problem, nanostructured silicon Si has been introduced to accommodate the strain/deformation and thus help reduce the risk of stress buildup. Several nano-geometries have been explored in the form of silicon nano-rods on a plane. The total electrode volume available in these cases is limited, however, primarily due to the low total volume offered by the nanostructures. Further, conventional manufacturing processes required to create such nanostructures using photolithography involve the use of several hazardous chemicals. Several embodiments of the disclosed additive deposition process can provide electrodes with controlled porosity to enable high energy density batteries.

FIGS. 6A-6B are schematic diagrams of a battery during various operating modes in accordance with embodiments of the present technology. For illustration purposes, the battery is described below using a lithium-ion battery 200 as an example. FIG. 6A shows the lithium-ion battery 200 during discharging. FIG. 6B shows the lithium-ion battery 200 during charging. In other embodiments, the battery can be other types of battery and supercapacitors containing, for instance, sodium, potassium, calcium, magnesium, cadmium, or copper ions. The battery can also contain a chemical sensor, an organic thin film transistor, an electromechanical actuator, a polymer light emitting diode, a gas separation membrane, a fuel cell, and/or other suitable components.

As shown in FIGS. 6A and 6B, the lithium-ion battery 200 can include a housing 202 holding a first electrode 204a, a second electrode 204b, and an electrolyte 208 between the first and second electrodes 204a and 204b. The first and second electrodes 204a and 204b are collectively referred to as electrodes 204. The lithium-ion battery 200 can also include salts such as LiPF₆, LiAsF₆, LiClO₄, LiBF₄, and lithium triflate contained in, for example, the electrolyte 208. In certain embodiments, the electrolyte 208 can include a non-liquid electrolyte having, for instance, a polymer electrolyte with suitable additives. In other embodiments, the electrolyte 208 can include other suitable types of electrolyte. Even though particular components are illustrated in FIGS. 6A and 6B, in other embodiments, the lithium-ion battery 200 can also include insulators, gaskets, vent holes, and/or other suitable components (not shown).

In certain embodiments, the first electrode 204a can include a carbonaceous material (e.g., graphite), Lithium metal (Li), Sodium metal (Na), Aluminum metal (Al), Magnesium metal (Mg), Silicon (Si), tin (Sn), zinc (Zn), lead (Pb), antimony (Sb), bismuth (Bi), silver (Ag), gold (Au), and/or other element electrodeposited on and alloy with lithium (Li) and or sodium (Na), Aluminum (Al), Magnesium (Mg), Silicon (Si), tin (Sn). In other embodiments, the first electrode 204a can also include a binary, ternary, or higher order mixtures of the elements that can be electrodeposited on and alloy with lithium (Li) or sodium (Na), Aluminum (Al), Magnesium (Mg), Silicon (Si), tin (Sn). Examples of binary mixtures include Sn—Zn, Sn—Au, Sn—Sb, Sn—Pb, Zn—Ag, Sb—Ag, Au—Sb, Sb—Zn, Zn—Bi, and Zn—Au. Examples of ternary mixtures include Sn—Zn—Sb, Sn—Zn—Bi, Sn—Zn—Ag, Sn—Sb—Bi, Sb—Zn—Ag, Sb—Zn—Au, and Sb—Sn—Bi. An example of a quaternary mixture can include Sn—Zn—Sb—Bi. In yet another embodiments, the first electrode 204a can also include intermetallic compounds of elements (e.g., the generally pure elements discussed above) and other elements that can be electrodeposited and alloy with lithium (Li) or sodium (Na). Examples of such intermetallic compounds include Sn—Cu, Sn—Co, Sn—Fe, Sn—Ni, Sn—Mn, Sn—In, Sb—In, Sb—Co, Sb—Ni, Sb—Cu, Zn—Co, Zn—Cu, and Zn—Ni.

In certain embodiments, the second electrode 204b can include a layered oxide (e.g., lithium cobalt oxide (LiCoO₂)), a polyanion (e.g., lithium iron phosphate (LiFePO₄)), Sulfur and its composites with carbonaceous material, or a spinel (e.g., lithium manganese oxide (LiMn₂O₄)). Other suitable materials for the second electrode 204b can include lithium nickel oxide (LiNiO₂), lithium iron phosphate fluoride (Li₂FePO₄F), lithium cobalt nickel manganese oxide (LiCo_{1/3}Ni_{1/3}Mn_{1/3}O₂), Li(LiₐNiₓMn_{y}Co_{z})O₂, and/or other suitable cathode materials. The first and/or second electrodes 204a and 204b can be formed using the foregoing compositions in accordance with embodiments of the additive deposition process described above with reference to FIGS. 2A-2F. The formed first and second electrodes 204a and 204b can have higher charge capacities and longer cycle lifetime than conventional electrodes.

As shown in FIG. 6A, during discharging, lithium ions 212 are extracted from the first electrode 204a and migrate toward the second electrode 204b via the electrolyte 208. The lithium ions 212 pass through the electrolyte 208 and are inserted into the second electrode 204b. As a result, a current 214 flows from the second electrode 204b past a load 216 to the first electrode 204a. As shown in FIG. 1B, during charging, a charger 218 provides a charging current 220 to the second electrode 204b. The charging current 220 causes lithium ions 212 to be extracted from the second electrode 204b and move toward the first electrode 204a.

Without being bound by theory, it is believed that the porosity of the first and/or second electrodes 204a and 204b can reduce the risk of electrode pulverization by allowing the scaffold structure 111 (FIG. 4) to expand and contract during operation. As a result, stress buildup in the first and/or second electrodes 204a and 204b can be reduced when compared to conventional electrodes. As such, the lithium-ion battery 200 can have higher charge capacity and longer cycle lifetime than conventional batteries.

In another application, several embodiments of the porous scaffold structure 111 can be used as thermal barrier coating (“TBC”) for mechanical components of gas turbines or other machinery with high operating temperatures. Such coating can include multi-layered metal-ceramic structures that can reduce temperatures of components, resulting in improved efficiencies and component creep life. For example, certain TBCs can reduce turbine operating temperatures by up to about 100-150° C. resulting in efficiency gains as a saving up to 40 million gallons of fuel a year for a fleet of 1000 aircraft.

For example, FIG. 7 is a cross-section diagram of a mechanical component 300 having a thermal barrier coating 310 incorporating porous scaffold structures 111 prepared according to several embodiments of the disclosed technology. As shown in FIG. 7, the mechanical component 300 can include a substrate 302 (e.g., a titanium or titanium alloy) with a TBC 310 on a surface of the substrate 302. The TBC 310 can include (i) a ceramic top layer 304 that provides a target temperature gradient, (ii) an intermediate bond coat 306 deposited on a base super-alloy to enhance TBC oxidation resistance and improve the adherence of the ceramic top layer, and (iii) a thermally grown oxide layer 308 over the substrate surface. In other embodiments, the TBC 310 can include other suitable materials and/or layers.

In certain embodiments, the ceramic top layer 302 can incorporate embodiments of the porous scaffold structure 111 as described with reference to, for example, FIGS. 2A-2F. It is believed that porosity of the ceramic top layer 302 can increase the effectiveness of TBC 310 due to insulation provided by the entrapped air. However, conventional manufacturing methods of plasma spray and/or Electron-beam physical vapor deposition have difficulty creating such porosity in the ceramic top layer 310. In contrast, as described in more detail above with reference to FIGS. 2A-2F, embodiments of the disclosed technology can be utilized to provide low thermal conductivity ceramic coatings having sufficient porosity to be useful as TBCs.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method for additive manufacturing of a porous scaffold structure, comprising:
depositing a first layer of a precursor material onto a deposition platform in a deposition pattern, the precursor material including a suspension of nano-particles;
sintering the deposited first layer of the precursor material to form a first solid structure of the nano-particles on the deposition platform;
depositing a second layer of the precursor material onto the first solid structure of the nano-particles; and
sintering the deposited second layer of the precursor material to form a second solid structure on the first solid structure, wherein the first and second solid structures forming a scaffold structure having hierarchical mesoscale of about 10 μm to about 250 μm to nanoscale of less than about 500 nm) porosity.

2. The method of claim 1, further comprising:
prior to depositing the second layer of the precursor material, depositing a sacrificial material onto the first solid structure on the deposition platform, the sacrificial material providing mechanical support to the first solid structure; and
removing the sacrificial material subsequent to sintering the deposited second layer of the precursor material.

3. The method of claim 1 wherein depositing the first layer includes depositing the first layer of the precursor material onto the deposition platform in a deposition pattern having a plurality of voids, and wherein sintering the deposited first layer includes forming the first solid structure having the plurality of voids.

4. The method of claim 1 wherein depositing the first layer includes controlling deposition of the first layer of the precursor material onto the deposition platform based on a target structure profile of the first solid structure.

5. The method of claim 1 wherein:
depositing the first layer includes depositing the first layer of a first precursor material; and
depositing the second layer includes depositing the second layer of a second precursor material different than the first precursor material.

6. The method of claim 1 wherein:
depositing the first layer includes depositing the first layer of the precursor material onto the deposition platform in a first deposition pattern; and
depositing the second layer includes depositing the second layer of the precursor material onto the deposition platform in a second deposition pattern different than the first deposition pattern.

7. The method of claim 1 wherein:
sintering the deposited first layer or second layer includes sintering the deposited first layer or second layer of the precursor material to form a first grid or a second grid having a plurality of rows and columns, respectively; and
the rows and columns are spaced apart from neighboring rows and columns by corresponding voids.

8. The method of claim 1 wherein:
sintering the deposited first layer or second layer includes sintering the deposited first layer or second layer of the precursor material to form a first grid or a second grid having a plurality of rows and columns, respectively; and
the individual rows and columns include additional porosity in addition to the hierarchical mesoscale of about 10 μm to about 250 μm to nanoscale of less than about 500 nm porosity of the scaffold structure.

9. A method for additive manufacturing of a porous scaffold structure, comprising:
depositing a first portion of a precursor material onto a deposition platform, the precursor material including a suspension of nano-particles;
forming a first solid structure of the nano-particles on the deposition platform from the deposited first layer of the precursor material;
depositing a second portion of the precursor material onto the formed first solid structure of the nano-particles; and
forming a second solid structure on the first solid structure from the deposited second layer of the precursor material, wherein the first and second solid structures being separated from one another by a plurality of hierarchical mesoscale of about 10 μm to about 250 μm or nanoscale of less than about 500 nm pores.

10. The method of claim 9 wherein forming the second solid structure includes forming the second solid structure on the first solid structure to form a matrix having multiple vertices interconnected by corresponding frame members of the nano-particles.

11. The method of claim 9 wherein forming the second solid structure includes forming the second solid structure on the first solid structure to form a matrix having multiple vertices interconnected by corresponding frame members of the nano-particles, and wherein the vertices are spaced apart from one another at a dimension of mesoscale of about 10 μm to about 250 μm or nanoscale of less than about 500 nm.

12. The method of claim 9 wherein forming the second solid structure includes forming the second solid structure on the first solid structure to form a matrix having multiple vertices interconnected by corresponding frame members of the nano-particles, and wherein the vertices and the frame members are spaced apart from one another to form the mesoscale of about 10 μm to about 250 μm or nanoscale of less than about 500 nm pores.

13. The method of claim 9 wherein:
forming the first solid structure includes forming the first solid structure on the deposition platform in a first pattern; and
forming the second solid structure includes forming the second solid structure on the first solid structure in a second pattern different than the first pattern.

14. The method of claim 9 wherein:
forming the second solid structure includes forming the second solid structure on the first solid structure to form a matrix having multiple vertices interconnected by corresponding frame members of the nano-particles; and
the frame members individually having porosity in addition to the mesoscale of about 10 μm to about 100 μm or nanoscale of less than about 500 nm porosity of the matrix.

15. A computing system having a processor and a memory containing instructions executable by the processor to cause the processor to perform a process comprising:
instructing a deposition head to deposit a first portion of a precursor material onto a deposition platform, the precursor material including a suspension of nano-particles;
instructing an energy source to provide a first energy stream toward the first portion of the precursor material, thereby sintering the first portion of the precursor material to form a first solid structure of the nano-particles on the deposition platform;
instructing the deposition head to deposit a second portion of the precursor material onto the formed first solid structure of the nano-particles; and
instructing the energy source to provide a second energy stream toward the second portion of the precursor material, thereby sintering the deposited second layer of the precursor material, wherein the first and second solid structures being separated from one another by a plurality of hierarchical mesoscale of about 10 μm to about 100 μm or nanoscale of less than about 500 nm pores.

16. The computing system of claim 15 wherein the second solid structure is on the first solid structure to form a matrix having multiple vertices interconnected by corresponding frame members of the nano-particles.

17. The computing system of claim 15 wherein the second solid structure is on the first solid structure to form a matrix having multiple vertices interconnected by corresponding frame members of the nano-particles, and wherein the vertices are spaced apart from one another at a dimension of mesoscale of about 10 μm to about 100 μm or nanoscale of less than about 500 nm.

18. The computing system of claim 15 wherein the second solid structure is on the first solid structure to form a matrix having multiple vertices interconnected by corresponding frame members of the nano-particles, and wherein the vertices and the frame members are spaced apart from one another to form the mesoscale of about 10 μm to about 250 μm or nanoscale of less than about 500 nm pores.

19. The computing system of claim 15 wherein instructing the deposition head includes instructing the deposition head to deposit the first portion of the precursor material on the deposition platform in a first pattern and to deposit the first portion of the precursor material on the deposition platform in a second pattern different than the first pattern.

20. The computing system of claim 15 wherein:
the second solid structure and the first solid structure form a matrix having multiple vertices interconnected by corresponding frame members of the nano-particles; and
the frame members individually having porosity, in addition to the mesoscale of about 10 μm to about 250 μm, of nanoscale of less than about 500 nm porosity of the matrix.
